(19) United States
(12) Patent Application Publication
(10) Pub. No.: US 2003/0077158 A1
(43) Pub. Date: Apr. 24, 2003

(54) Apparatus for towing a service vehicle by a truck tractor

(76) Inventors: Roy A. Amos, Portland, OR (US); James A. Woods, Cornelius, OR (US)

Correspondence Address: James D. Givnan, Jr., 8175 S. W. Ernst Road, Portland, OR, 97225, US

(21) Appl. No.: 10/314,467

(22) Filed: Dec. 9, 2002

Related U.S. Application Data
(63) Continuation-in-part of application No. 09/843,346, filed on Apr. 27, 2001.

(51) Int. Cl. B66C 1/00

(52) U.S. Cl. 414/563

(57) ABSTRACT

An apparatus for installation in a pickup truck box and which includes a tow beam positionably carried in a support housing positioned by a hydraulic cylinder to raise or lower the tow beam during coupling of the beam end to a truck tractor fifth wheel. Downward movement of the distal end of the beam, by the cylinder, lifts the pickup truck rear end for towing of same. Truck tractor retrieval for servicing may accordingly be accomplished by a single driver.

### BACKGROUND OF THE INVENTION

This is a continuation-in-part of copending patent application Ser. No. 09/843,346 Apparatus For Towing A Service Vehicle By A Truck Tractor—filed Apr. 27, 2001.

The servicing of truck tractors often entails retrieving the truck tractor from a remote site for delivery to the shop performing periodic maintenance work. Present practice involves the use of two persons, one driving the service vehicle to the site of the truck tractor and accompanied by a second party to drive the truck tractor to the maintenance shop. The practice of using two workmen for the retrieval of a truck tractor to be serviced constitutes a costly effort from a man-hour standpoint over a period of several months.

U.S. Pat. No. 4,555,214 discloses a towing beam fitted at its ends with king pins with one end of the beam also fitted with a hydraulic cylinder for lifting the distal end of the beam for fifth wheel engagement. A lift chain on the beam extends about the rear frame members of a truck tractor to be towed with the chain lifted by a second cylinder. The system enables the towing of an over-the-road tractor by a second like tractor both having a fifth wheel. Such a system entails the use of two semi-truck tractors which is both costly and cumbersome with limited maneuverability.

U.S. Pat. No. 5,988,664 discloses a frame carried by the fifth wheel of a truck to be towed with the framework attachable to the fifth wheel of a towing truck tractor. A pivotally mounted beam is positionable by a hydraulic cylinder capable of imparting upward movement to the framework which lifts the frame of the towed tractor for towing purposes. Both vehicles must be fifth wheel equipped.

U.S. Pat. No. 4,000,823 discloses a pickup truck mounted apparatus including a hydraulic cylinder for raising a tow bar engaged with the front end of the vehicle to be towed.

U.S. Pat. No. 4,543,030 discloses an apparatus for placement on the tiltable fifth wheel of a truck tractor and having a towing beam adjustably mounted with a crosswise tow bar at its distal end for lifting engagement with a towed vehicle. A pair of lift cylinders supported by the tow truck frame impart motion to the adjustably carried tow beam.

U.S. Pat. No. 5,845,920 shows an apparatus for towing a truck with a tow truck vehicle both equipped with fifth wheels. A tow beam is pivotally segmented and houses a hydraulic cylinder for lifting a beam segment coupled to the fifth wheel of the towed truck. A lift chain also serves to elevate the towed vehicle.

Flaugh, U.S. Pat. No. 4,316,617, discloses an apparatus for securement to an automobile with the apparatus having an upright frame 10 secured to the rear bumper area of the automobile. A frame mounted winch at 86 upon retrieval of a cable 88 imparts lifting to the rear end of the automobile as the hook equipped end of the cable is supported by a boom mounted eyelet 72. The automobile is additionally fitted with a roof mounted plate 12 and boom retainer 54 which support a pair of struts 14 for securement to frame 10. Accordingly, automobile 94 is substantially modified for supporting the patented apparatus. Whether or not roof structures of current automobiles are of adequate strength to support a substantial portion of the automobile weight is questionable. It may be said that an automobile so altered in appearance and weight is of reduced utility for other purposes. Further, most current automobiles are of the front wheel drive type and hence are not suited for towing with the front wheels in road contact.

The Aquila, U.S. Pat. No. 4,000,823, discloses a lift for use in towing a disabled automobile. A segmented beam 26 is pivotally mounted at 40 on a frame 10 in a pickup truck bed. A single acting cylinder 50 serves only to elevate a tow bar 30 for lifting of the vehicle being towed. No provision is made for extension or retraction of beam 26.

### SUMMARY OF THE PRESENT INVENTION

The present invention is embodied in a towing apparatus suitable for installation in the box of a small service truck enabling the service truck to be towed by a semitrailer truck tractor needing servicing to a maintenance facility.

The apparatus is carried in the bed of a pickup truck or other suitable vehicle with a tow beam extensible therefrom for engagement with the fifth wheel of a truck tractor to be serviced. A base of the apparatus houses hydraulic components as well as a power source to render the unitary apparatus self contained. As a pickup truck or other service vehicle becomes the towed vehicle during retrieval of a truck tractor, all may be done by one person. The apparatus is of a size and weight to be contained within a pickup truck box. The apparatus, being self contained, is readily transferable from one vehicle to another. A hydraulic cylinder positions a support member for the tow beam which, upon coupling to the fifth wheel of a towing vehicle (truck tractor), serves as a lever to lift the apparatus and the rear end of a pickup truck or other vehicle on which the base is mounted. Mechanical locks secure the tow beam against axial displacement.

Important objectives include the provision of a tow apparatus which permits installation in a light duty service vehicle, such as a quarter ton pickup truck, permitting a single operator to retrieve a semitrailer truck tractor, needing servicing, from a remote location by enabling rapid attachment of the service vehicle to the truck tractor and subsequent return of both vehicles all by the single operator; the provision of an apparatus for installation in the box of a pickup truck which enables the towing of the pickup truck by a semitrailer truck tractor; the provision of an apparatus which is compact shape and unitary construction to permit permanent mounting, if so desired, in a pickup truck while leaving space in the truck box for the transport of other articles.

### BRIEF DESCRIPTION OF THE DRAWINGS

In the drawings:

FIG. 1 is an elevational view of the present apparatus in use to tow a service vehicle such as a pickup truck;

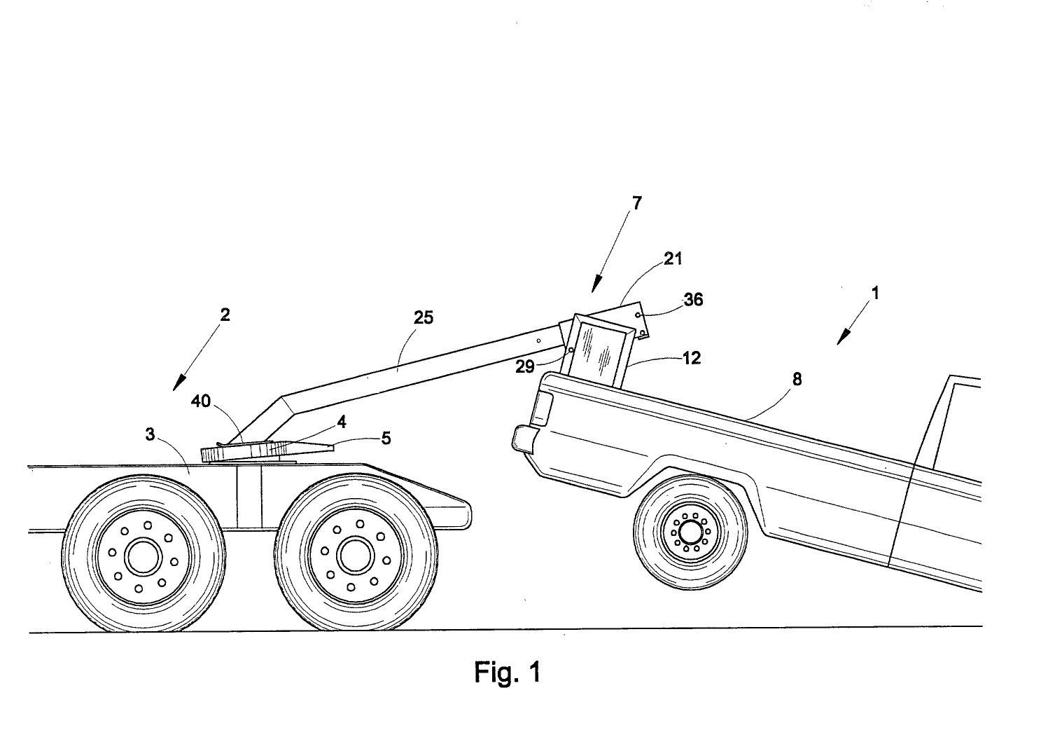

FIG. 2 is a view similar to FIG. 1 but enlarged with fragments broken away for illustrative purposes;

FIGS. 3 and 4 are perspective views of the apparatus respectively in retracted and extended positions;

FIG. 5 is a plan view of the apparatus in an extended positions;

FIG. 6 is a vertical sectional view taken along line 6-6 of FIG. 5.

### DETAILED DESCRIPTION OF THE PREFERRED EMBODIMENT

With continuing attention to the drawings wherein applied reference numerals indicate parts similarly hereinafter identified, the reference numeral 1 indicates generally a pickup truck, termed herein as a service vehicle, for use by the person assigned the task of retrieving the truck tractor indicated generally at 2 for periodic servicing purposes. A rearward frame portion 3 of the truck tractor is shown with a fifth wheel 4 thereon. A ramp extension 5 of the fifth wheel is typical of conventional fifth wheel structures which receives in normal use the forward end of the trailer and a king pin, all being standard items in the trucking industry.

The present apparatus is indicated generally at 7 for installation as a unit in a truck box structure at 8. While a pickup truck vehicle is illustrated as a service vehicle, upon an understanding of the invention it will be apparent that other vehicles may prove suitable for use in conjunction with the present apparatus. Bolted in place on a truck box bed 10 of a pickup truck is a welded steel base including a framework 11 including spaced apart upright members 12 of welded construction and braces at 13. Cover plates 14 may be provided to conceal the following described hydraulic and electrical components.

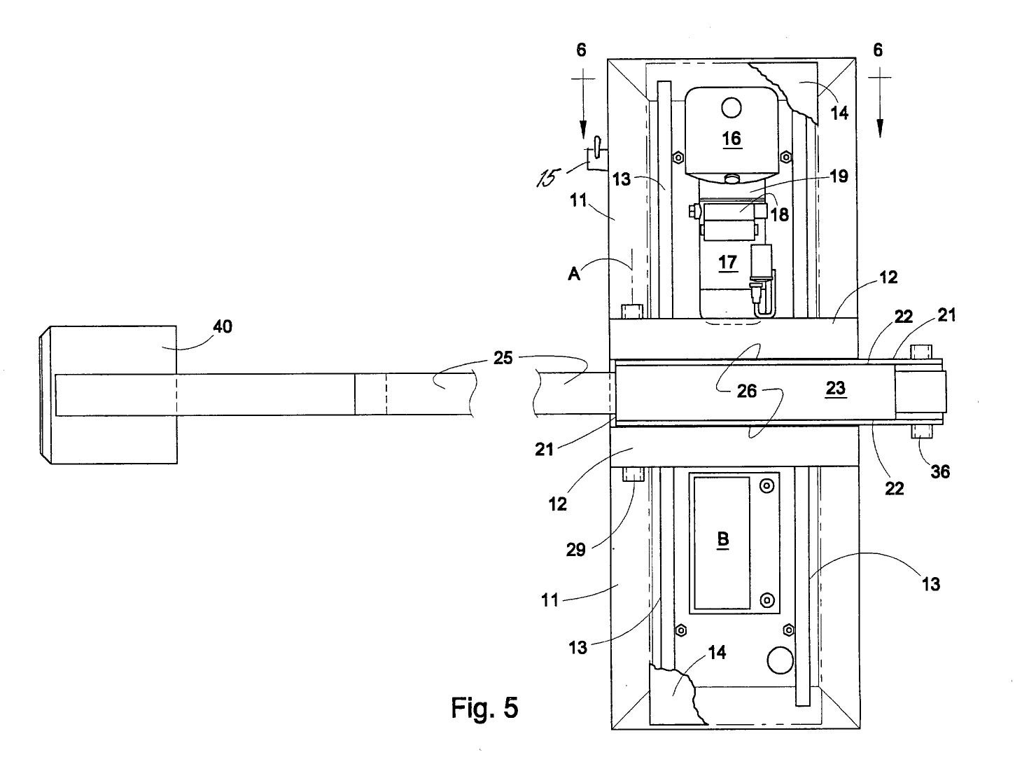

Carried by base 11 is a hydraulic oil tank 16 shown in FIG. 5 which serves a fluid circuit including a pump 19 powered by an electric motor 17 for powering a double acting hydraulic cylinder 20. The hydraulic circuit additionally includes a unitized pressure relief valve and four way solenoid actuated control valve 18 serving hydraulic lines (not shown) in communication with the opposite ends of cylinder 20. Valve 18 is in circuit with a three position toggle switch 15 for operator control of cylinder 20. A 12 volt battery is at B.

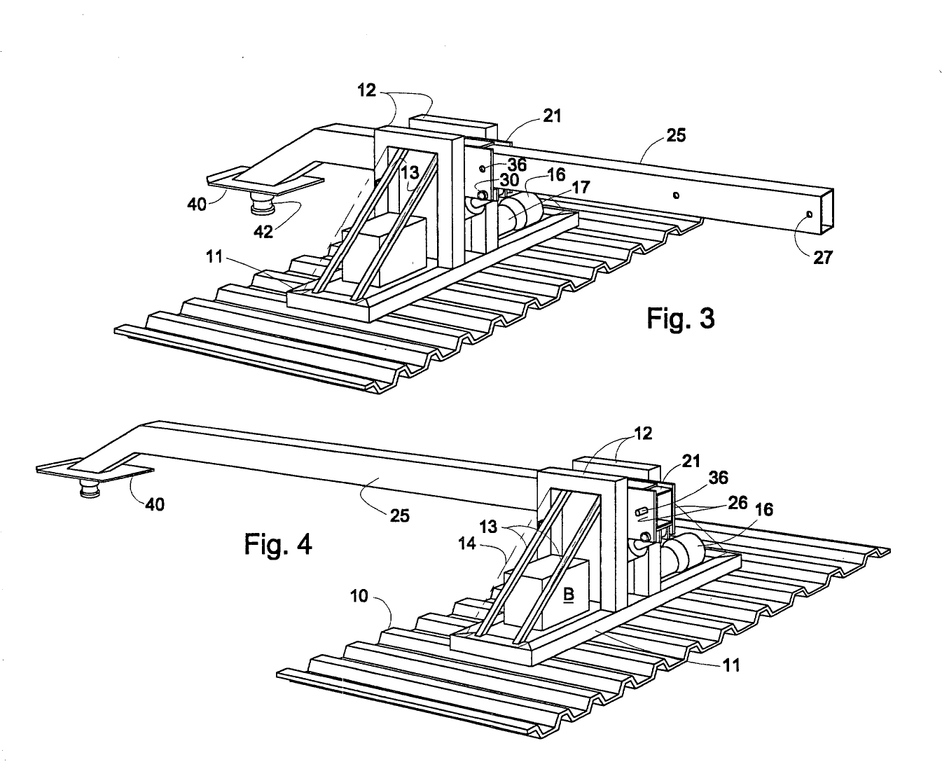

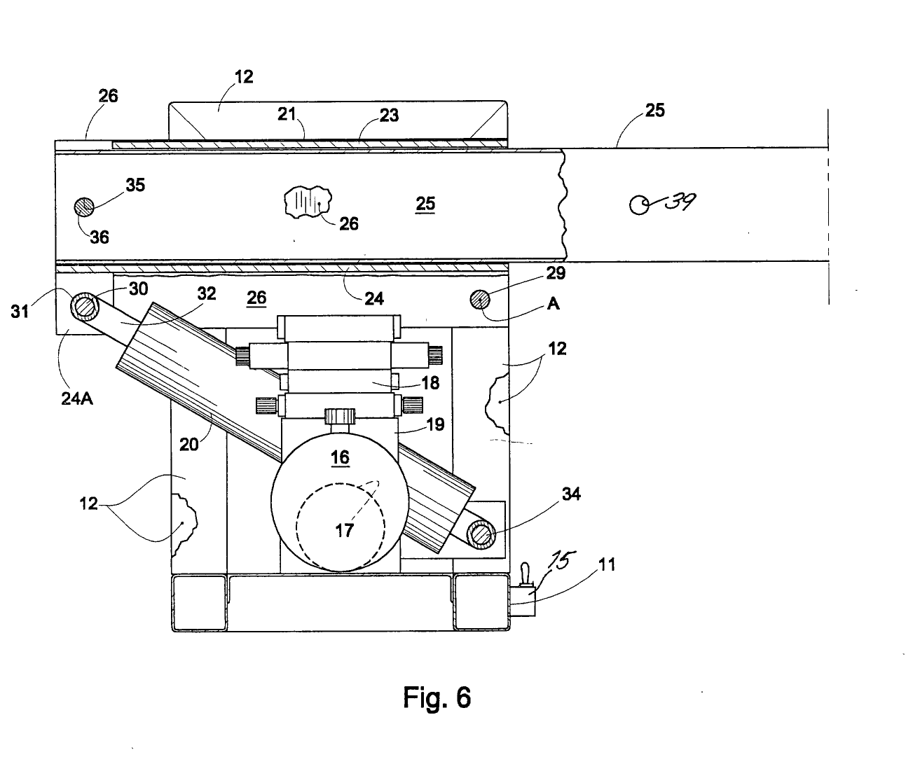

Carried by upright members 12 is a tow beam support housing 21 which is a weldment having side walls 22 in FIG. 5 and top and bottom walls 23 and 24 which form a four sided support housing for a tow beam 25 shown as a box beam. Beam support housing 21 is carried by a frame mounted pivot pin 29 permitting travel of the support housing about a horizontal axis at A along with tow beam 25 therein. A pair of side plates 26 (FIG. 4) are welded to side walls 22 of the support housing for reinforcement of same and additional bearing surface areas. The side plates extend below support housing 21. A clevis 24A (FIG. 6) on member 21 receives a pin 30 journaled in a bearing 31 on a piston rod 32 of hydraulic cylinder 20. The base end of the cylinder is swingably supported for travel about a pin 34 carried by upright structures 12. Tow beam 25 is preferably of box beam construction having an aperture at 35 for reception of a locking pin 36 to lock the beam in an extended operable position. A like aperture for pin reception is provided in a medial segment of the tow beam for locking the beam in a retracted position as shown in FIG. 3.

The distal end of tow beam 25 carries a skid plate 40 with the plate supporting a king pin 42. Prior to use tow beam 25 is lengthwise deployed from its stowed position shown in FIG. 3 to the extended position shown in FIG. 4, whereat skid plate 40 is positioned for contact with fifth wheel 4 of truck tractor 2. For hookup of the tow beam, the same is extended and locked into place in beam support housing 21. Upon entry of king pin 42 into the fifth wheel receptacle, the same is locked in place using conventional fifth wheel structure. Upon such locking of tow beam 25 in place within the support structure, hydraulic cylinder 20 is pressurized for extension of piston rod 32 with downward loading imparted to skid plate 40 and resultant lifting of the back end of service vehicle 1 with the tow beam serving as a second class lever with lift via pin 29.

Conventional fifth wheel construction permits limited rocking of the fifth wheel about a transversely extending horizontal axis which feature enables skid plate 40 to remain in surface engagement with the fifth wheel during lifting of the back end of service vehicle 1.

At completion of a tow, the tow beam is returned to its initial position, approximately horizontal, by retraction of piston rod 32 to unload skid plate 40 and permitting unlocking of king pin 42 from fifth wheel 4. Prior to such unlocking, the towed vehicle 1 is in place with its rear wheels in ground contact.

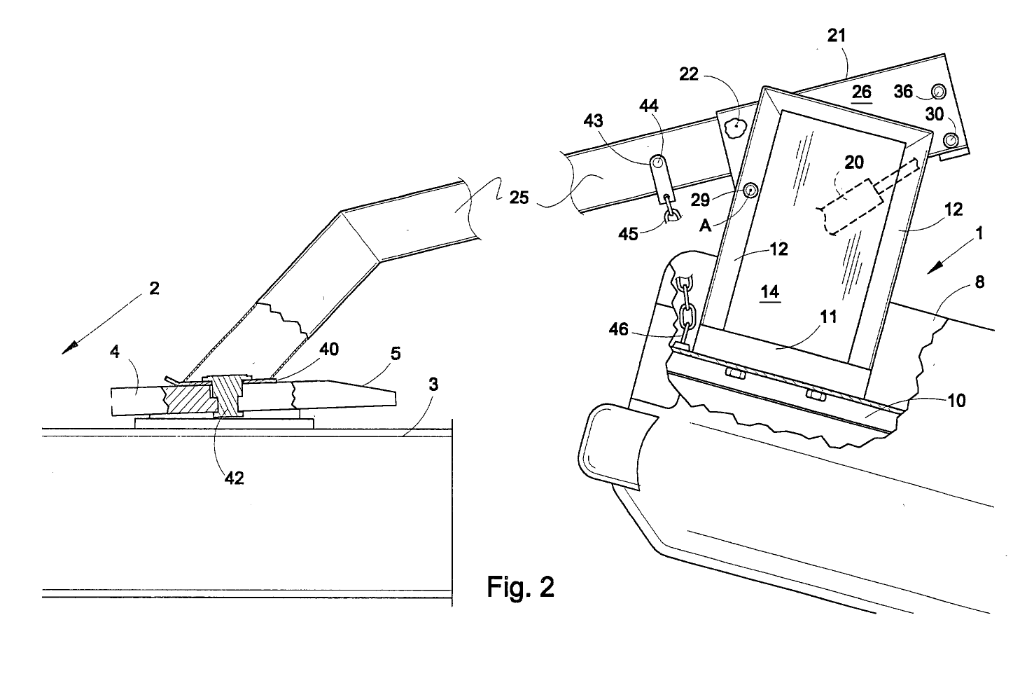

During towing the steering wheel of the towed vehicle is, of course, secured against movement. Tow beam 25 is locked during towing by a safety lock 43 (FIG. 2) having a pair of upright arms apertured to receive a pin 44 in a beam opening 39. The lower end of each arm has an opening to receive a chain 45 provided with a hook at one end for engagement with a shackle as at 46 in place on truck bed 10. Upon disengagement with the fifth wheel the tow beam locking pin 36 is removed, the beam retracted through support housing 21 and pin 36 inserted in a beam aperture to lock the beam in a forward stowed position in service vehicle box structure 8.

While we have shown but one embodiment of the invention, it will be apparent to those skilled in the art that the invention may be embodied still otherwise without departing from the spirit and scope of the claimed invention.

Having thus described the invention, what is desired to be secured by a Letters Patent is:

We claim:

1. A unitary apparatus for lifting and towing a service vehicle having a bed with a truck tractor equipped with a fifth wheel, said apparatus for installation in the bed of the vehicle and including,
a base for installation on the bed of the service vehicle adjacent one end of the bed, spaced apart upright members on said base,
a tow beam having a proximal end and a distal end,
a beam support housing carried by said upright member and disposed about said tow beam permitting axial positioning of the tow beam,
pivot means constituting a fulcrum having a horizontal axis and coupling said beam support housing to said spaced apart upright members for travel of the tow beam and said beam support member about a horizontal axis,
locking means for securing said tow beam to said beam support housing,
powered means in place on said base and including a motor, a pump and hydraulic cylinder, the latter coupled to said support member for rotatably positioning the support housing about the horizontal axis of the fulcrum,
a control for said powered means,
said tow beam including a king pin at its distal end for engagement with the tractor mounted fifth wheel,
actuation of said powered means imparting a lifting force to said proximal end of the tow beam and to said beam support housing to elevate the base and that end of the service vehicle supporting said baser towing of the service vehicle.

2. The apparatus claimed in claim 1 wherein said locking means is a locking pin insertable through apertures in said beam support member and said tow beam for lock pin insertion.

3. The apparatus claimed in claim 1 additionally including a safety lock detachably coupled to said tow beam and said base to prevent upward rotation of the tow beam about said horizontal axis during towing of a service vehicle.
